(19) United States
(12) Patent Application Publication
(10) Pub. No.: US 2022/0007323 A1
(43) Pub. Date: Jan. 6, 2022

(54) TIMING ADJUSTMENT MECHANISM FOR SIGNAL TRANSMISSION IN NON-TERRESTRIAL NETWORK

(71) Applicant: MediaTek Singapore Pte. Ltd., Singapore (SG)

(72) Inventors: Dan LI, Shanghai (CN); Shiang-Jiun LIN, Hsinchu City (TW); I-Kang FU, Hsinchu City (TW); Xuancheng ZHU, Shanghai (CN)

(21) Appl. No.: 17/366,408

(22) Filed: Jul. 2, 2021

(30) Foreign Application Priority Data
Jul. 3, 2020 (CN) PCT/CN2020/100238
Jun. 30, 2021 (CN) 202110733833.9

(51) Int. Cl. H04W 56/00; H04B 7/185

(52) U.S. Cl. CPC H04W 56/0045; H04B 7/1851; H04W 56/006

(57) ABSTRACT

A method is provided. The method includes the following steps: obtaining a predetermined initial timing for signal transmission from user equipment (UE) to a satellite through a gateway in a non-terrestrial network; and in response to a number of failures of the signal transmission being greater than or equal to a first predetermined number, utilizing the UE to shift timing for a subsequent signal transmission using a timing-adjustment mechanism.

### CROSS REFERENCE TO RELATED APPLICATIONS

This application claims priority of PCT Patent Application No. PCT/CN2020/100238, filed on Jul. 3, 2020, and this application also claims priority of China Patent Application No. 202110733833.9, filed on Jun. 30, 2021, the entirety of which are incorporated by reference herein.

### BACKGROUND OF THE INVENTION

### Field of the Invention

The present invention relates to wireless communication, and, in particular, to transmission-timing adjustment mechanisms for a Non-Terrestrial Network (NTN).

### Description of the Related Art

Non-Terrestrial Network (NTN) systems can provide communication services in areas without Terrestrial Network (TN) services, such as the ocean, desert, mountain, high altitude, etc. In addition, NTN communication can also be used as a backup scheme for TN. When the TN service is unavailable for some reasons, the terminal can try to communicate through the NTN. NTN communication and TN communication have different physical characteristics in time delay.

### Signal Time Delay in NTN

Because the communication distance between a user terminal and a satellite changes with the movement of the satellite, the signal delay of the NTN is relatively large and time varying compared to a TN communication system. Taking a GEO (geostationary earth orbiting) satellite at an altitude of 35778 km as an example, assuming that the base station is on the ground, the elevation angle of the GEO satellite relative to the gateway of the base station and the user terminal is about 10 degrees above the horizon. FIG. 1 shows the round-trip propagation delay of the GEO satellite at an altitude of 35778 km. For example, the round-trip propagation delay (i.e., RTD) from the user terminal to the GEO satellite, and to the gateway may drift between 535.4 ms and 514.4 ms in a day (24 hours), and the maximum drift rate is ±0.25 us/s, as shown in FIG. 1.

FIG. 2 shows the round-trip propagation delay of the LEO satellite at an altitude of 600 km. Taking the LEO satellite at an altitude of 600 km as an example, assuming that base station is on the ground (e.g., at sea level), when the user terminal enters the coverage of the LEO satellite at an elevation angle of 10 degrees, the round-trip propagation delay from the user terminal to the LEO satellite, and to the gateway of the base station drifts between 10 ms and 26 ms in the coverage of the LEO satellite as the LEO satellite moves, and the maximum drift rate is ±80 μs/s as shown in FIG. 2.

FIG. 3 shows a common propagation delay and residual propagation delay of a LEO satellite 310, assuming that the beam layout is based on the 3 dB coverage angle (θ_{3 dB}). In order to use radio resources more efficiently and integrate NTN and TN more efficiently, an NTN system can divide propagation delay into two parts. Taking the location of the nearest distance between the satellite 310 and the terminal in cell 0 as a reference point 320, the propagation delay of this reference point 320 is set as the common propagation delay. The propagation delay of the location of each of other cells can be further divided into the common propagation delay and the residual propagation delay, as shown in FIG. 3.

Thus, the common propagation delay in the beam can be compensated by the satellite or the user terminal, and the delay of residual propagation is supported by the communication system design.

### BRIEF SUMMARY OF THE INVENTION

In an exemplary embodiment, a method is provided. The method includes the following steps: obtaining a predetermined initial timing for signal transmission from user equipment (UE) to a satellite through a gateway in a non-terrestrial network; and in response to a number of failures of the signal transmission being greater than or equal to a first predetermined number, utilizing the UE to shift timing for a subsequent signal transmission using a timing-adjustment mechanism.

In some embodiments, when the UE is not able to obtain information of a sign bit of a drift rate of propagation delay from the UE to the satellite through the gateway, the UE performs the timing-adjustment mechanism to shift the timing of each round of signal transmission using a positive and negative alternating step sequence. The positive and negative alternating sequence is expressed by S(n₂)*Δt, and the function S(n₂) is expressed as: S(n₂)=(−1)ⁿ^{₂}┌n₂/2┐+1; where Δt denotes the smallest timing-shift unit defined in a transmission protocol used by the UE; the function S(n₂) denotes the adjustment step per shift; and n₂ is an integer between 0 and a second predetermined number.

In some embodiments, in response to the number of signal-transmission failures being smaller than the first predetermined number, utilizing the UE to adjust transmission power for the subsequent signal transmission. In response to the number of signal-transmission failures being greater than or equal to a predetermined parameter, the UE determines that the transmission between the UE and the satellite was not successfully established.

An embodiment of the present invention provides a method. The method includes: utilizing user equipment (UE) to perform the following steps: estimating a drift rate and its sign bit of propagation delay from the UE to a satellite through a gateway of a base station in a non-terrestrial network; performing a timing-adjustment mechanism to adjust timing for signal transmission from the UE to the satellite through the gateway using the estimated drift rate and its sign bit.

In some embodiments, the step of estimating a drift rate and its sign bit of propagation delay from the UE to a satellite through a gateway of a base station in a non-terrestrial network includes: obtaining ephemeris data of a satellite in a non-terrestrial network; obtaining position information of a gateway of a base station in the non-terrestrial network; calculating position and trajectory information of the satellite using the obtained ephemeris data; obtaining position information of the UE from a GNSS sensor disposed in the UE; calculating propagation delay by dividing a relative distance between the UE and the satellite through the gateway by speed of light; and estimating the drift rate of the propagation delay and its sign bit according to the calculated trajectory information of the satellite.

In some embodiments, the step of estimating a drift rate and its sign bit of propagation delay from the UE to a satellite through a gateway of a base station in a non-terrestrial network includes: utilizing the UE to perform the following steps: performing an estimation algorithm to estimate timing offset of a downlink channel from the satellite to the UE; estimating the drift rate and its sign bit of the downlink channel using the estimated timing offset of the downlink channel; setting the drift rate and its sign bits of the downlink channel as those of an uplink channel from the UE to the satellite.

In some embodiments, the step of estimating a drift rate and its sign bit of propagation delay from the UE to a satellite through a gateway of a base station in a non-terrestrial network comprises: utilizing the UE to perform the following steps: obtaining northern or southern hemisphere information of the UE from a GNSS (global navigation satellite system) sensor disposed in the UE; obtaining northern or southern hemisphere information of the gateway; obtaining approximate latitude information of the satellite; and predicting a drift rate and its sign bit of the propagation delay using the obtained northern or southern hemisphere information of the UE, the obtained northern or southern hemisphere information of the gateway, and the obtained approximated latitude information of the satellite.

In some embodiments, wherein the step of estimating a drift rate and its sign bit of propagation delay from the UE to a satellite through a gateway of a base station in a non-terrestrial network comprises: utilizing the UE to perform the following steps: obtaining the drift rate of the propagation delay of the satellite from broadcast system information or from the Internet.

In another exemplary embodiment, a device is provided. The device includes: processing circuitry configured to: obtain a predetermined initial timing for signal transmission from the device to a satellite through a gateway in a non-terrestrial network; and shift timing for a subsequent signal transmission using a timing-adjustment mechanism in response to a number of signal-transmission failures being greater than or equal to a first predetermined number.

In some embodiments, when the processing circuitry is not able to obtain information of a sign bit of a drift rate of propagation delay from the device to the satellite through the gateway, the processing circuitry uses the timing-adjustment mechanism to shift the timing of each round of signal transmission using a positive and negative alternating step sequence. The positive and negative alternating sequence is expressed by S(n₂)*Δt, and the function S(n₂) is expressed as: S(n₂)=(−1)ⁿ^{₂}┌n₂/2┐+1; where Δt denotes the smallest timing-shift unit defined in a transmission protocol used by the processing circuitry; the function S(n₂) denotes the adjustment step per shift; and n₂ is an integer between 0 and a second predetermined number.

In some embodiments, in response to the number of failures of the signal transmission being smaller than the first predetermined number, the processing circuitry adjusts transmission power for the subsequent signal transmission. In response to the number of failures of the signal transmission being greater than or equal to a predetermined parameter, the processing circuitry determines that the transmission between the UE and the satellite was not successfully established.

In yet another exemplary embodiment, a device is provided. The device includes processing circuitry configured to: estimate a drift rate and its sign bit of propagation delay from the device to a satellite through a gateway of a base station in a non-terrestrial network; and perform a timing-adjustment mechanism to adjust timing for signal transmission from the device to the satellite through the gateway using the estimated drift rate and its sign bit.

In some embodiments, the processing circuitry is further configured to: obtain ephemeris data of a satellite in a non-terrestrial network; obtain position information of a gateway of a base station in the non-terrestrial network; calculate position and trajectory information of the satellite using the obtained ephemeris data; obtain position information of the device from a GNSS (global navigation satellite system) sensor disposed in the device; calculate propagation delay by dividing a relative distance between the device and the satellite through the gateway by speed of light; and estimate the drift rate of the propagation delay and its sign bit according to the calculated trajectory information of the satellite.

In some embodiments, the processing circuitry is further configured to: perform an estimation algorithm to estimate timing offset of a downlink channel from the satellite to the device; estimate the drift rate and its sign bit of the downlink channel using the estimated timing offset of the downlink channel; and set the drift rate and its sign bits of the downlink channel as those of an uplink channel from the device to the satellite.

In some embodiments, the processing circuitry is further configured to: obtain northern or southern hemisphere information of the device from a GNSS (global navigation satellite system) sensor disposed in the device; obtain northern or southern hemisphere information of the gateway; obtain approximate latitude information of the satellite; and predict a drift rate and its sign bit of the propagation delay using the obtained northern or southern hemisphere information of the device, the obtained northern or southern hemisphere information of the gateway, and the obtained approximated latitude information of the satellite.

In some embodiments, the processing circuitry is further configured to: obtain the drift rate of the propagation delay of the satellite from broadcast system information or from the Internet.

### BRIEF DESCRIPTION OF THE DRAWINGS

The present invention can be more fully understood by reading the subsequent detailed description and examples with references made to the accompanying drawings, wherein:

FIG. 1 shows the round-trip propagation delay of the GEO satellite at an altitude of 35778 km;

FIG. 2 shows the round-trip propagation delay of the LEO satellite at an altitude of 600 km;

FIG. 3 shows a common propagation delay and residual propagation delay of a LEO satellite;

FIG. 4 is a diagram of a Non-Terrestrial Network (NTN) system in accordance with an embodiment of the invention;

FIG. 5 is a diagram showing the step sequence used in the timing-adjustment mechanism in accordance with an embodiment of the invention;

FIG. 6 is a diagram showing the step sequence used in the timing-adjustment mechanism in accordance with another embodiment of the invention;

FIG. 7 is a diagram showing the step sequence used in the timing-adjustment mechanism in accordance with yet another embodiment of the invention;

FIG. 8 is a diagram showing the step sequence used in the timing-adjustment mechanism in accordance with yet another embodiment of the invention;

FIG. 9 is a flow chart of a method of timing adjustment in a non-terrestrial network (NTN) in accordance with an embodiment of the invention; and

FIG. 10 is a flow chart of a method of timing adjustment in a non-terrestrial network (NTN) in accordance with another embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The following description is presented to enable one of ordinary skill in the art to make and use the invention, and is provided in the context of a patent application and its requirements. Various modifications to the embodiments and the generic principles and features described herein will be readily apparent to those skilled in the art. Thus, the present invention is not intended to be limited to the embodiments shown, but is to be accorded the widest scope consistent with the principles and features described herein.

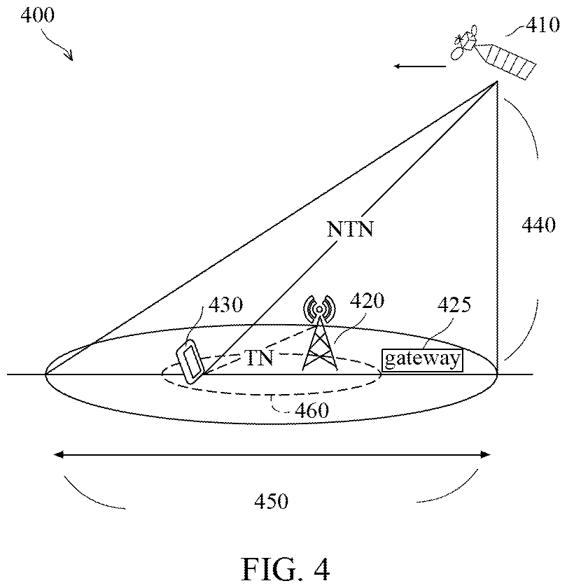

FIG. 4 is a diagram of a Non-Terrestrial Network (NTN) system in accordance with an embodiment of the invention.

For ease of description, the NTN system 400 may include a satellite 410, a base station 420, a gateway 425, and user equipment (UE) 430, as shown in FIG. 4. In some embodiments, the NTN system 400 may include one or more satellites 410, one or more base stations 420, and one or more devices of UEs 430. The satellite 410 has a satellite-orbit altitude 440 which depends on the type of the satellite 410 (e.g., GEO satellite or LEO satellite). The coverage region of the satellite 410 has a radius 450. In some embodiments, the base station 420 can be regarded as an “Evolved Node B” (i.e., abbreviated as “eNB”) if the LTE (long term evolution) protocol is used. The UE 430 may be a mobile electronic device such as a smartphone, a tablet PC, etc., but the invention is not limited thereto. In some embodiments, the UE 430 may include a GNSS (global navigation satellite system) sensor or a GPS (global positioning system) sensor that is capable of receiving positioning information from one or more satellites, and the UE 430 may determine its position information using the received positioning information.

In some embodiments, the base station 420, the gateway 425, and the UE 430 may be within a land-network cell 460. The gateway 425 may be between a wired network (e.g., Internet) and a wireless network (e.g., NTN or TN). In addition, a plurality of base stations 420 may be connected to the gateway 425, and the gateway 425 and these base stations 420 may be located in different positions, where the gateway 425 may be capable of communicating with the satellite 410 and UE 430. In some other embodiments, the gateway 425 may be disposed in the satellite 410, which allows the UE 430 to directly communicate with the satellite 410.

The communication between the satellite 410 and the gateway 425 or the user terminal 430 may be regarded as the communication in a non-terrestrial network (NTN), and the communication between the gateway 425 and the user terminal 430 may be regarded as the communication in a terrestrial network (TN). The following embodiments will be described with reference to FIG. 4.

### Embodiment 0: Predetermined Timing

### Case 0-1:

In an embodiment, the UE 430 may perform precise initial-propagation-delay pre-compensation using location information of the UE 430, the satellite 410, and the gateway 425. For example, the UE 430 may calculate the position and trajectory information of the satellite 410 using ephemeris data of the satellite 410, where the UE 430 may obtain the ephemeris data from broadcast by the satellite 410 or from the Internet. In addition, the UE 430 may obtain its own position information using the GNSS (global navigation satellite system) sensor disposed in the UE 430, and obtain the position information of the base station 420 using system information or from the Internet.

Accordingly, the UE 430 can calculate and pre-compensate the initial propagation delay for the round-trip route from the UE 430 to the satellite 410 and to the gateway 425 very precisely using the speed of light and the positions of the UE 430, satellite 410, and base station 420. For example, the initial propagation delay can be calculated by dividing the overall distance of the aforementioned round-trip route by the speed of light. Afterwards, the timing-adjustment mechanism performed by the UE 430 can calculate the residual propagation delay using the propagation delay drifting scheme.

### Case 0-2:

In an embodiment, the UE 430 can perform rough initial-propagation-delay pre-compensation by a fixed value for each beam. Afterwards, the timing-adjustment mechanism performed by the UE 430 can calculate the residual propagation delay using the pre-compensation error and the propagation delay drifting scheme.

### Embodiment 1: Failure Event Being Detected

### Case 1-1:

In an embodiment, if the UE 430 does not receive any random access response (RAR) from the satellite 410 within a predetermined random-access response window or the received random access response does not contain the transmitted preamble after the UE 430 transmits a signal to the gateway 425 (or the satellite 410), the UE 430 may determine that the signal transmission fails. Here, if the LTE (long-term evolution) protocol is used between the UE 430 and the base station 420 (or the gateway 425), the aforementioned signal may be any signal transmitted in the PRACH (physical random access channel), PUSCH (physical uplink shared channel), PUCCH (physical uplink control channel), etc., but the invention is not limited thereto. It should be noted that the aforementioned signal may be any other signal if a different protocol is used between the UE 430 and the base station 420 (or the gateway 425).

If the UE 430 determines that the current signal transmission fails, the UE 430 may increase the value of preamble-transmission counter by 1. When the UE 430 determines that the signal transmission fails N1 times consecutively (i.e., the preamble-transmission counter is equal to N1), the UE 430 may start the timing-adjustment mechanism to correct the transmission timing. For example, if the LTE protocol is used between the UE 430 and the base station 420, the maximum transmission times is defined in the preamble of the signal, namely, preambleTransMax. If the UE 430 determines that the signal transmission fails, the UE 430 may adjust the transmission power for the next signal transmission. If the number of signal transmissions exceed the parameter preambleTransMax, the UE 430 may determine that the transmission power meets the requirements, and it may indicate a RACH (random access procedure) problem to upper layers. In this embodiment, the value N1 is equal to the parameter preambleTransMax.

### Case 1-2:

In another embodiment, the UE 430 may start the timing-adjustment mechanism after the first round of signal transmission fails. For example, when the UE 430 performs one round of the timing adjustment mechanism, the UE 430 may obtain the adjusted timing and adjusted power for the next signal transmission. That is, the timing adjustment mechanism can be performed to calibrate the timing error, and the signal is retransmitted to ensure the reliability of the signal transmission. Take preamble transmission in the LTE system as an example, the value N3 may be the maximum number of rounds of timing-adjustment mechanism. In this case, N3 can be equal to the parameter preambleTransMax, and N1=1 (i.e., N3 and N1 are positive integers). In order to achieve signal-timing alignment between the base station 420 and the UE 430 as soon as possible, the maximum power can be used in the first round of signal transmission. Case 1-3:

In yet another embodiment, the values N3 and N1 described in Case 1-2 can be in a random combination that satisfies the equation (1):

N₁+N₃=preambleTransMax (1)

### Embodiment 2: Timing-Adjustment Mechanism

For convenience of description, it is assumed that the timing-shift value can be expressed by a step sequence of S(n₂)*Δt, where Δt denotes the smallest timing-shift unit (e.g., may be several microseconds); n₂ denotes the number of timing-shift rounds; the function S(n₂) denotes the adjustment step per shift.

### Case 2-1:

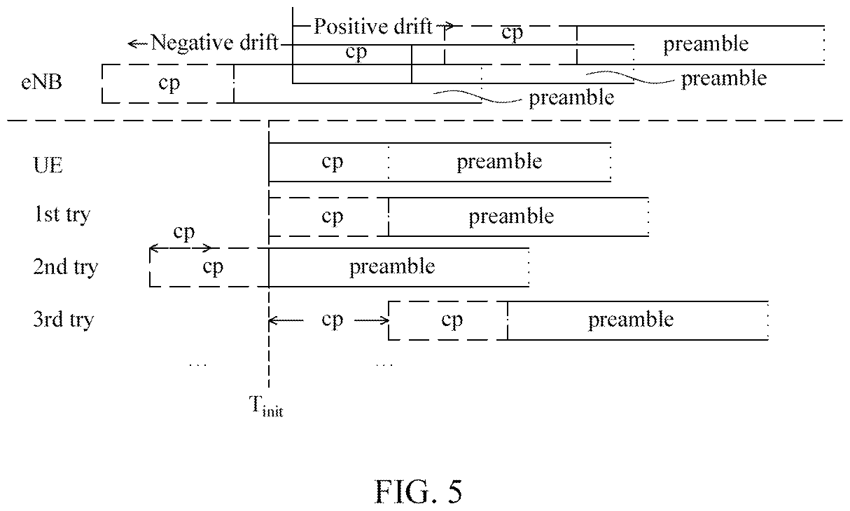

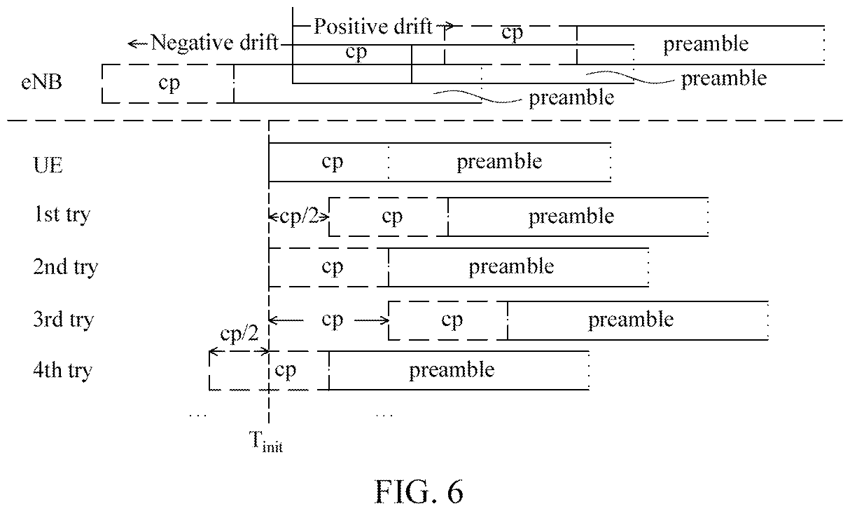

In an embodiment, the UE 430 is not able to obtain information of the sign bit of the draft rate of the propagation delay. Since the propagation delay at the base station 420 (i.e., eNB) may drift in both negative and positive directions, as shown in the upper portion of FIG. 5, the timing-adjustment mechanism performed by the UE 430 can arrange the transmission timing in a positive and negative alternating sequence, which is expressed by equation (2):

S(n₂)=(−1)ⁿ^{₂}┌n₂/2┐ (2)

wherein n₂ is an integer from 0 to N2. In this case, Δt=CPₗₑₙ, where CPₗₑₙ (i.e., cyclic prefix length) denotes the maximum tolerable-timing-error range for normal signal transmission. For example, in the first round of signal transmission (i.e., n₂=1), the function S(n₂) equals to 0, and the UE 430 may pre-compensate the propagation delay using the predetermined initial timing Tina. In the second round of signal transmission (i.e., n₂=2), the function S(n₂) equals to 1, the UE 430 may pre-compensate the propagation delay using Tᵢₙᵢₜ+CPₗₑₙ. In the third round of signal transmission (i.e., n₂=3), the function S(n₂) equals to −1, and the UE 430 may pre-compensate the propagation delay using Tᵢₙᵢₜ−CPₗₑₙ, and so on. The UE 430 will keep performing the timing-adjustment mechanism until the transmitted signal is successfully detected by the base station 420 (or the satellite 410).

### Case 2-2:

In another embodiment, the UE 430 is not able to obtain information of the sign bit of the drift rate of the propagation delay, but the UE 430 has pre-compensated the initial propagation delay precisely enough. Thus, the UE 430 may perform subsequent signal transmissions based on predetermined timing of previous successful signal transmissions. For example, the propagation delay of the transmitted signal is always positive in preamble transmission in a legacy TN system. However, in the NTN system, the propagation delay may drift negatively. In this case, the UE 430 may perform the timing-adjustment mechanism using equation (3):

S(n₂)=(−1)ⁿ^{₂}┌n₂/2┐+1 (3)

$$Δ t = \frac{{CP}_{len}}{2} ,$$

wherein n₂ is an integer from 0 to N2. In this case, where CPₗₑₙ denotes the maximum tolerable-timing-error range for normal signal transmission. For example, in the first round of the timing-adjustment mechanism (i.e., n₂=1), the UE 430 may pre-compensate the propagation delay using Tᵢₙᵢₜ+CPₗₑₙ/2 so as to allow tolerance of small positive and negative drifts of the propagation delay. In the second round of the timing-adjustment mechanism (i.e., n₂=2), the UE 430 may pre-compensate the propagation delay using Tᵢₙᵢₜ. In the third sound of the timing-adjustment mechanism (i.e., n₂=3), the UE 430 may pre-compensate the propagation delay using Tᵢₙᵢₜ+CPₗₑₙ, and so on.

Specifically, the UE 430 will pre-compensate the propagation delay using Tᵢₙᵢₜ CPₗₑₙ/2 at the first try for signal transmission because the offset CPₗₑₙ/2 is a better guess that allows tolerance of small positive and negative drifts of the propagation delay in the beginning. As a result, it is highly probable to perform a successful signal transmission at the first try, and thus no subsequent retries for signal transmission are needed.

### Case 2-3:

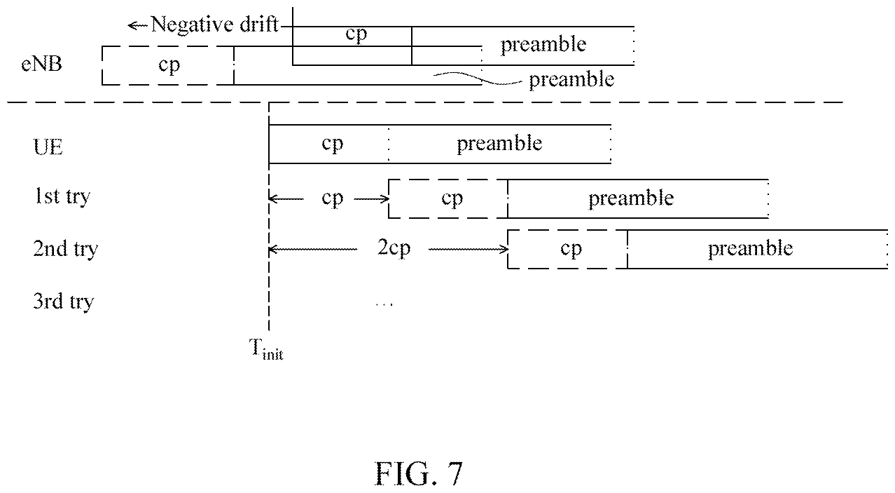

In yet another embodiment, it is assumed that the UE 430 can obtain the information about the sign bit of the drift rate of the propagation delay, and the sign bit is negative. In this case, it indicates that that propagation delay may drift toward the negative direction, as shown in the upper portion of FIG. 7. Thus, the UE 430 may perform the timing-adjustment mechanism using an increasing step sequence by setting the function S(n₂)=n₂, as shown in the lower portion of FIG. 7, where n₂ is an integer from 0 to N2, and Δt=CPₗₑₙ.

### Case 2-4:

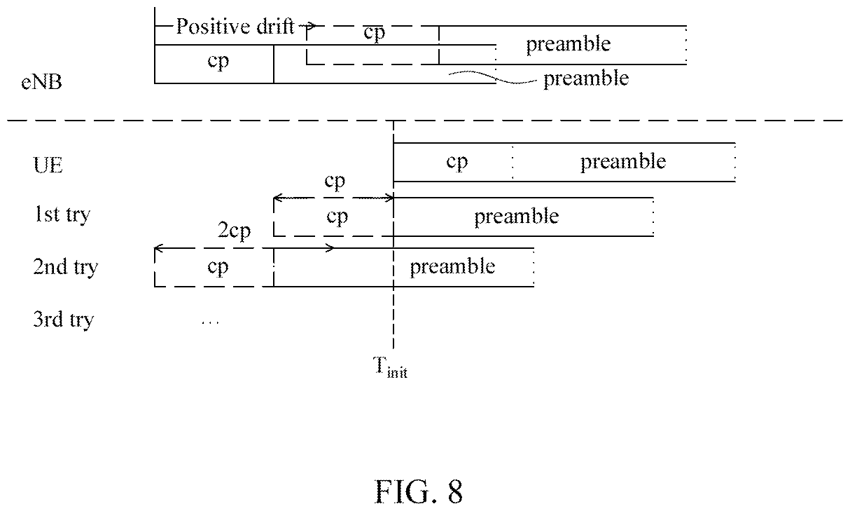

In yet another embodiment, it is assumed that the UE 430 can obtain the information about the sign bit of the drift rate of the propagation delay, and the sign bit is positive. In this case, it indicates that that propagation delay may drift toward the positive direction, and the propagation delay may become larger and larger, as shown in the upper portion of FIG. 8. Thus, the UE 430 may perform the timing-adjustment mechanism using a decreasing step sequence by setting the function S(n₂)=−n₂, as shown in the lower portion of FIG. 8, where n₂ is an integer from 0 to N2, and Δt=CPₗₑₙ.

### Embodiment 3: Setting the Maximum Timing-Shifting Times

### Case 3-1:

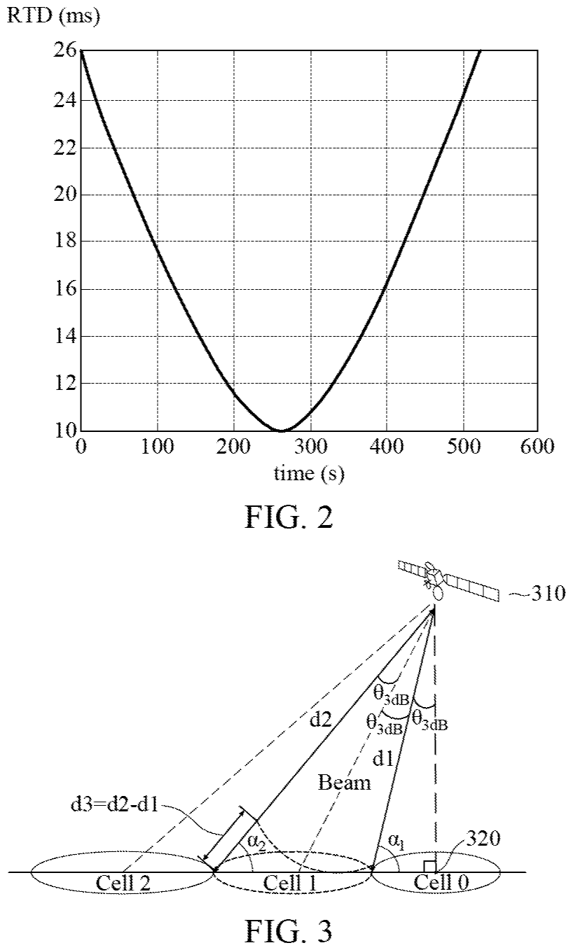

In an embodiment, the value N2 may refer to the maximum timing-shifting times. It is assumed that the UE 430 may obtain information about the maximum drift rate d_rateₘₐₓ of the propagation delay of the satellite 410 from the broadcast system information (e.g., from a monitoring station that collects ephemeris of various satellites) or from the Internet. In addition, the UE 430 may also obtain the period of updating location information Period_{location} from the broadcast system information or from the Internet. If the propagation delay drift both in the negative direction and positive direction as described in Case 2-1 and Case 2-2, the UE 430 may set N₂=*┌Period_{location}*|d_rateₘₐₓ|/Δt┐. If the propagation delay drifts in one direction as described in Case 2-3 and Case 2-4, the UE 430 may set N₂=┌Period_{location}*d_rateₘₐₓ|/Δt┐. In an example, the satellite 410 may be a LEO satellite with height of 600 km, and the NB-IoT (Narrow Band Internet of Things) technology is used. As shown in FIG. 2, the maximum drift rate d_rateₘₐₓ is +80 μs/s. Given that the CP length (i.e., CPₗₑₙ) is 266 μs in the NB-IoT preamble format 1,

$$Δ t = \frac{{CP}_{len}}{2} = 133 μ s ,$$

if the period of updating location information Period_{location}=2.5 s, the UE 430 can calculate N₂=4. In addition, different cells may have different maximum timing-shifting times.

### Case 3-2:

In another embodiment, it is assumed that the UE 430 may obtain information about the precise drift rate d_rate of the propagation delay of the satellite 410 from the broadcast system information or from the Internet. In addition, the UE 430 may also obtain the period of updating location information Period_{location} from the broadcast system information or from the Internet. If the propagation delay drifts both in the negative direction and positive direction as described in Case 2-1 and Case 2-2, the UE 430 may set N₂=2*┌Period_{location}*|d_rate|/Δt┐. If the propagation delay drifts in one direction as described in Case 2-3 and Case 2-4, the UE 430 may set N₂=┌Period_{location}|d_rate|/Δt┐.

### Embodiment 4: Obtaining the Drift Rate of the Propagation Delay

### Case 4-1:

In an embodiment, the UE 430 may estimate the drift rate of the propagation delay using precise location information of the UE 430, satellite 410, and gateway 425. For example, the UE 430 may obtain the ephemeris data of the satellite 410 from the broadcast system information or from the Internet, and the UE 430 may calculate the position and trajectory information of the satellite using the obtained ephemeris data. In addition, the UE 430 may obtain its own position information from the GNSS disposed in the UE 430, and obtain the position information of the gateway 425 from the broadcast system information or from the Internet.

Specifically, the broadcast ephemeris data, which is continuously transmitted by the satellite 410 (or a monitoring station), contains information about the orbit of the satellite, and time of validity of this orbit information. Accordingly, the UE 430 can calculate the orbit of the satellite 410 using the ephemeris data of the satellite 410, and predict the accurate position of the satellite 410 at a given time. In addition, the UE 430 may calculate the propagation delay by dividing the relative distance between the UE 430 and satellite 410 through the gateway 425 by the speed of light. The UE 430 can also calculate the drift rate and its sign bit of the propagation delay using the calculated trajectory information of the satellite 410.

### Case 4-2:

In another embodiment, the UE 430 may estimate the drift rate and its sign bit of the propagation delay by performing an estimation algorithm of the downlink timing offset. For example, because the downlink channel and the uplink channel between the UE 430 and the satellite 410 are reciprocal, the UE 430 may use the drift rate of the propagation delay in the downlink channel as that in the uplink channel.

For example, the estimation algorithm of the downlink timing offset can be implemented by a Kalman filter, which is a recursive estimator with which signal and/or time series are analyzed to estimate the state of a system and to remove any measurement errors and/or distortions that may be present.

### Case 4-3:

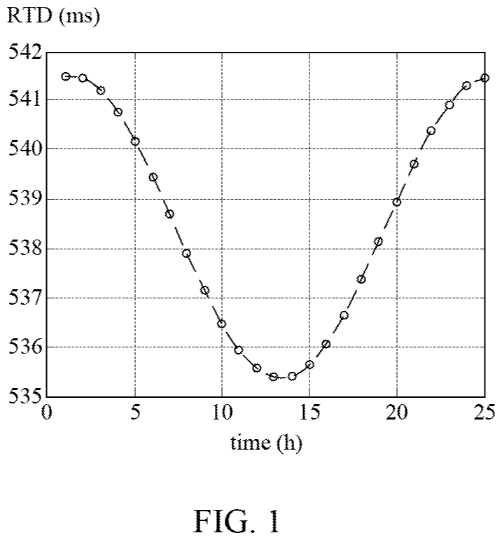

In yet another embodiment, the UE 430 may predict the drift curve of the propagation delay and obtain the drift rate and its sign bit of timing drift over time according to rough latitude information of the UE 430 and the gateway 425, and the propagation delay drift curve of the satellite 410. For example, the UE 430 may obtain the northern or southern hemisphere information of the UE 430 from the GNSS sensor disposed in the UE 430 or from fixed information. In addition, the UE 430 may obtain the northern or southern hemisphere information of the gateway 425 from the broadcast system information, from the Internet, or from fixed information. The UE 430 may also obtain approximate latitude information of the satellite 410 from broadcast system information, from the Internet, or from fixed information. In an example, if the satellite 410 is a GEO satellite at an altitude of 35778 km, the UE 430 can calculate the drift rate and its sign bit of the propagation delay over time using the aforementioned information. For example, the drift rate of the propagation delay is negative in the first half of a day, and the drift rate of the propagation delay is positive in the second half of a day, as shown in FIG. 1.

### Case 4-4:

In yet another embodiment, Case 4-4 is similar to Case 4-3, and the difference is that the UE 430 in Case 4-4 may obtain the drift rate of the propagation delay of the satellite 410 from broadcast system information or from the Internet.

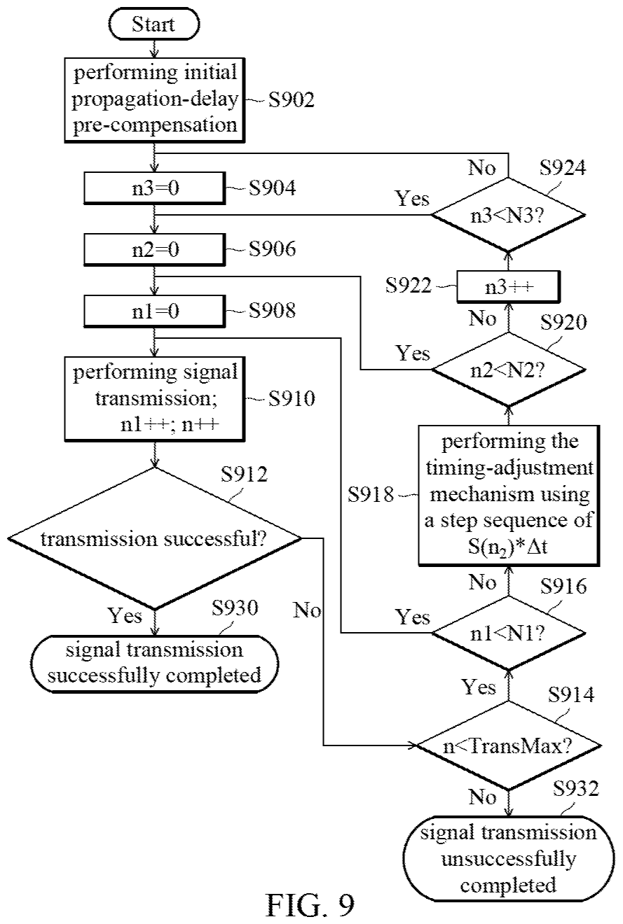

FIG. 9 is a flow chart of a method of timing adjustment in a non-terrestrial network (NTN) in accordance with an embodiment of the invention. Please refer to FIG. 4 and FIG. 9.

In step S902, the UE 430 performs initial propagation-delay pre-compensation. For example, when the UE 430 starts to perform the initial propagation-delay pre-compensation, the UE 430 may set variables n, n1, n2, and n3 to an initial value of 0, where variables n, n1, n2, and n3 are natural numbers.

In steps S904, S906, and S908, the UE 430 sets variables n3, n2, and n1 to 0, respectively.

In step S910, the UE 430 performs signal transmission to the satellite 410 through the gateway 425, and increases variables n and n1 by 1. For example, the variable n may represent the number of signal transmissions that have been performed by the UE 430.

In step S912, the UE 430 determines whether the signal transmission is successful. If it is determined that the signal transmission is successful, step S930 is performed to indicate a successful signal transmission. Thus, the configuration of power and timing of the successful signal transmission can be used by the UE 430 for subsequent signal transmissions. For example, if the UE 430 does not receive any random-access response (RAR) from the satellite 410 within a predetermined random-access response (RAR) window or the received random access response does not contain the transmitted preamble after the UE 430 transmits a signal to the gateway 425 (or base station 420), the UE 430 may determine that the signal transmission fails. Here, if the LTE (long-term evolution) protocol is used between the UE 430 and the base station 420 (or the gateway 425), the aforementioned signal may be any signal transmitted in the PRACH (physical random access channel), PUSCH (physical uplink shared channel), PUCCH (physical uplink control channel), etc., but the invention is not limited thereto. It should be noted that the aforementioned signals may be any other signal if a different protocol is used between the UE 430 and the base station 420 (or the gateway 425).

In step S914, the UE 430 determines that whether the number of signal transmissions performed is lower than the predetermined parameter TransMax. If it is determined that the number of signal transmissions performed is lower than the predetermined parameter TransMax, step S916 is performed. If it is determined that the number of signal transmissions performed is not smaller than the predetermined parameter TransMax, step S932 is performed to indicate that transmission from the UE 430 to the satellite 410 cannot be successfully established.

In step S916, the UE 430 determines whether the variable n1 is smaller than the first predetermined number N1. If it is determined that the variable n1 is smaller than the first predetermined number N1, the flow goes back to step S910. If it is determined that the variable n1 is not smaller than the first predetermined number N1, step S918 is performed.

In step S918, the UE 430 performs a timing-adjustment mechanism to shift the timing for signal transmission using a step sequence of S(n₂)*Δt, and increases the variable n2 by 1. For example, Δt denotes the smallest timing-shift unit (e.g., may be several microseconds) defined in the transmission protocol (e.g., LTE) used by the UE 430; the function S(n₂) denotes the adjustment step per shift.

In step S920, the UE 430 determines whether the variable n2 is smaller than a second predetermined number N2. If it is determined that the variable n2 is smaller than the second predetermined number N2, the flow goes back to step S908. If it is determined that the variable n2 is not smaller than the second predetermined number N2, step S922 is performed to increase the variable n3 by 1.

In step S924, the UE 430 determines whether the variable n3 is smaller than a third predetermined number N3. If it is determined that the variable n3 is smaller than the third predetermined number N3, the flow goes back to step S906. If it is determined that the variable n3 is not smaller than the third predetermined number N3, the flow goes back to step S904.

It should be noted that the first predetermined number N1, the second predetermined number N2, and the third predetermined number N3 can be referred to in the aforementioned embodiments 0 to 4.

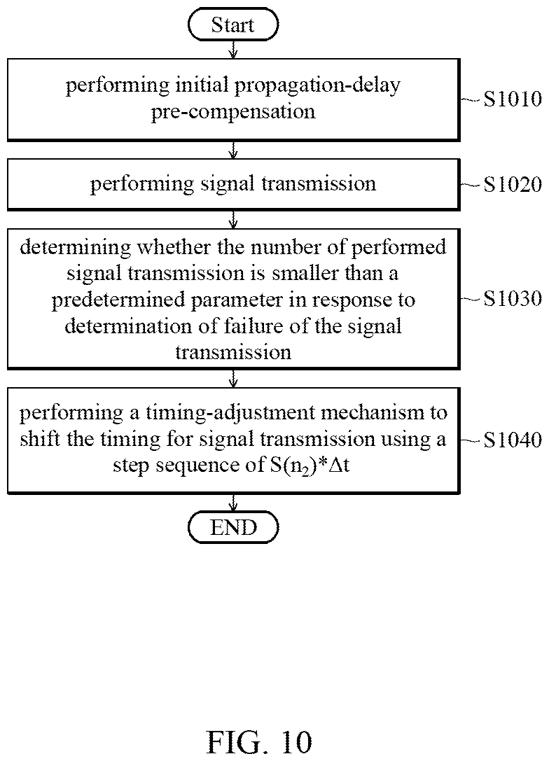

FIG. 10 is a flow chart of a method of timing adjustment in a non-terrestrial network (NTN) in accordance with an embodiment of the invention. Please refer to FIG. 4 and FIG. 10.

In step S1010, the UE 430 performs initial propagation-delay pre-compensation. For example, when the UE 430 starts to perform the initial propagation-delay pre-compensation, the UE 430 may set variables n, n1, n2, and n3 to an initial value of 0, where variables n, n1, n2, and n3 are natural numbers.

In step S1020, the UE 430 performs signal transmission to the satellite 410 through the gateway 425.

In step S1030, the UE 430 determines whether the number of signal transmissions performed is lower than a predetermined parameter (e.g., TransMax) in response to determination of failure of the signal transmission.

In step S1040, the UE 430 performs a timing-adjustment mechanism to shift the timing for signal transmission using a step sequence of S(n₂)*Δt. For example, Δt denotes the smallest timing-shift unit (e.g., may be several microseconds) defined in the transmission protocol (e.g., LTE) used by the UE 430; the function S(n₂) denotes the adjustment step per shift.

In view of the above, a device and a method are provided, which are capable of performing a timing-adjustment mechanism for signal transmission in a non-terrestrial network (NTN), and allows the UE to make a better guess of the initial timing for signal transmission at the first try. Once a successful signal transmission is performed at the first try, no subsequent retries for signal transmission are needed. In addition, the device and method provided in the present invention are further capable of determining the drift rate and its sign bit using various ways so as to accurately determine the timing required for pre-compensating the propagation delay from the UE to the satellite through the gateway.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method, comprising:
obtaining a predetermined initial timing for signal transmission from user equipment (UE) to a satellite through a gateway in a non-terrestrial network; and
in response to a number of signal-transmission failures being greater than or equal to a first predetermined number, utilizing the UE to shift timing for a subsequent signal transmission using a timing-adjustment mechanism.

2. The method as claimed in claim 1, wherein when the UE is not able to obtain information of a sign bit of a drift rate of propagation delay from the UE to the satellite through the gateway, the UE performs the timing-adjustment mechanism to shift the timing of each round of signal transmission using a positive and negative alternating step sequence.

3. The method as claimed in claim 2, wherein the positive and negative alternating sequence is expressed by S(n₂)*Δt, and the function S(n₂) is expressed as: S(n₂)=(−1)ⁿ^{₂}┌n₂/2┐+1;
where Δt denotes the smallest timing-shift unit defined in a transmission protocol used by the UE; the function S(n₂) denotes the adjustment step per shift; and n₂ is an integer between 0 and a second predetermined number.

4. The method as claimed in claim 3, wherein the method further includes: setting the second predetermined number by obtaining information about a maximum drift rate of the propagation delay which is broadcast by system information or from the Internet.

5. The method as claimed in claim 3, wherein Δt is half of cyclic prefix length.

6. A method, comprising:
utilizing user equipment (UE) to perform the following steps:
estimating a drift rate and its sign bit of propagation delay from the UE to a satellite through a gateway of a base station in a non-terrestrial network;
performing a timing-adjustment mechanism to adjust timing for signal transmission from the UE to the satellite through the gateway using the estimated drift rate and its sign bit.

7. The method as claimed in claim 6, wherein the step of estimating the drift rate and its sign bit of propagation delay from the UE to a satellite through a gateway of a base station in a non-terrestrial network comprises:
obtaining ephemeris data of a satellite in a non-terrestrial network;
obtaining position information of a gateway of a base station in the non-terrestrial network;
calculating position and trajectory information of the satellite using the obtained ephemeris data;
obtaining position information of the UE from a GNSS (global navigation satellite system) sensor disposed in the UE;
calculating propagation delay by dividing a relative distance between the UE and the satellite through the gateway by speed of light; and
estimating the drift rate of the propagation delay and its sign bit according to the calculated trajectory information of the satellite.

8. The method as claimed in claim 6, wherein the step of estimating the drift rate and its sign bit of propagation delay from the UE to a satellite through a gateway of a base station in a non-terrestrial network comprises:
utilizing the UE to perform the following steps:
executing an estimation algorithm to estimate timing offset of a downlink channel from the satellite to the UE;
estimating the drift rate and its sign bit of the downlink channel using the estimated timing offset of the downlink channel;
setting the drift rate and its sign bits of the downlink channel as those of an uplink channel from the UE to the satellite.

9. The method as claimed in claim 6, wherein the step of estimating the drift rate and its sign bit of propagation delay from the UE to a satellite through a gateway of a base station in a non-terrestrial network comprises:
utilizing the UE to perform the following steps:
obtaining northern or southern hemisphere information of the UE from a GNSS (global navigation satellite system) sensor disposed in the UE;
obtaining northern or southern hemisphere information of the gateway;
obtaining approximate latitude information of the satellite; and
predicting a drift rate and its sign bit of the propagation delay using the obtained northern or southern hemisphere information of the UE, the obtained northern or southern hemisphere information of the gateway, and the obtained approximate latitude information of the satellite.

10. The method as claimed in claim 6, wherein the step of estimating the drift rate and its sign bit of propagation delay from the UE to a satellite through a gateway of a base station in a non-terrestrial network comprises:
utilizing the UE to perform the following steps:
obtaining the drift rate of the propagation delay of the satellite from broadcast system information or from the Internet.

11. A device, comprising:
processing circuitry configured to:
obtain a predetermined initial timing for signal transmission from the device to a satellite through a gateway in a non-terrestrial network; and
shift timing for a subsequent signal transmission using a timing-adjustment mechanism in response to the number of signal-transmission failures being greater than or equal to a first predetermined number.

12. The device as claimed in claim 11, wherein when the processing circuitry is not able to obtain information of a sign bit of a drift rate of propagation delay from the device to the satellite through the gateway, the processing circuitry performs the timing-adjustment mechanism to shift the timing of each round of signal transmission using a positive and negative alternating step sequence.

13. The device as claimed in claim 12, wherein the positive and negative alternating sequence is expressed by S(n₂)*Δt, and the function S(n₂) is expressed as: S(n₂)=(−1)ⁿ^{₂}┌n₂/2┐+1;
where Δt denotes the smallest timing-shift unit defined in a transmission protocol used by the processing circuitry; the function S(n₂) denotes the adjustment step per shift; and n₂ is an integer between 0 and a second predetermined number.

14. The device as claimed in claim 13, wherein the processing circuitry sets the second predetermined number by obtaining information about a maximum drift rate of the propagation delay which is broadcast by system information or from the Internet.

15. The device as claimed in claim 13, wherein Δt is half of cyclic prefix length.

16. A device, comprising:
processing circuitry configured to:
estimate a drift rate and its sign bit of propagation delay from the device to a satellite through a gateway of a base station in a non-terrestrial network; and
perform a timing-adjustment mechanism to adjust timing for signal transmission from the device to the satellite through the gateway using the estimated drift rate and its sign bit.

17. The device as claimed in claim 16, wherein the processing circuitry is further configured to:
obtain ephemeris data of a satellite in a non-terrestrial network;
obtain position information of a gateway of a base station in the non-terrestrial network;
calculate position and trajectory information of the satellite using the obtained ephemeris data;
obtain position information of the device from a GNSS (global navigation satellite system) sensor disposed in the device;
calculate propagation delay by dividing a relative distance between the device and the satellite through the gateway by the speed of light; and
estimate the drift rate of the propagation delay and its sign bit according to the calculated trajectory information of the satellite.

18. The device as claimed in claim 16, wherein the processing circuitry is further configured to:
perform an estimation algorithm to estimate timing offset of a downlink channel from the satellite to the device;
estimate the drift rate and its sign bit of the downlink channel using the estimated timing offset of the downlink channel; and
set the drift rate and its sign bits of the downlink channel as those of an uplink channel from the device to the satellite.

19. The device as claimed in claim 16, wherein the processing circuitry is further configured to:
obtain northern or southern hemisphere information of the device from a GNSS (global navigation satellite system) sensor disposed in the device;
obtain northern or southern hemisphere information of the gateway;
obtain approximate latitude information of the satellite; and
predict a drift rate and its sign bit of the propagation delay using the obtained northern or southern hemisphere information of the device, the obtained northern or southern hemisphere information of the gateway, and the obtained approximate latitude information of the satellite.

20. The device as claimed in claim 16, wherein the processing circuitry is further configured to:
obtain the drift rate of the propagation delay of the satellite from broadcast system information or from the Internet.
